(19) United States
(12) Patent Application Publication
(10) Pub. No.: US 2022/0094614 A1
(43) Pub. Date: Mar. 24, 2022

(54) SYSTEMS FOR AND METHODS OF MODELLING, ANALYSIS AND MANAGEMENT OF DATA NETWORKS

(71) Applicant: VMware, Inc., Palo Alto, CA (US)

(72) Inventors: Ahmed Khurshid, Champaign, IL (US); Matthew Caesar, Champaign, IL (US); Mo Dong, San Jose, CA (US); Philip Brighten Godfrey, Champaign, IL (US); Santhosh Prabhu Muraleedhara Prabhu, Urbana, IL (US); Wenxuan Zhou, Champaign, IL (US)

(21) Appl. No.: 17/542,119

(22) Filed: Dec. 3, 2021

Related U.S. Application Data
(63) Continuation of application No. 15/683,650, filed on Aug. 22, 2017.
(60) Provisional application No. 62/378,191, filed on Aug. 22, 2016.

(51) Int. Cl. H04L 12/26

(52) U.S. Cl. CPC H04L 43/04

(57) ABSTRACT

Systems for and methods of modelling, analyzing and managing data networks are provided. In an embodiment, a plurality of network device interfaces are configured to collect state information for a plurality of network devices. A computer-implemented model of the network comprises a data structure, which may be graph-based. The data structure comprises a plurality of snapshots of the network, each snapshot representing the network at a particular point in time, and the data structure comprises a representation of possible data flow and data packet processing within the network. The data structure contains normalized representations of the network devices corresponding to the location. The normalized representation for each device contains a set of packet processing rules. A user-interface is configured to receive queries from a user that request verification of network policies and predictions of network behavior. The user-interface is configured to display responses to the queries that are obtained using the data structure.

### CROSS-REFERENCE TO RELATED APPLICATIONS

This application is a continuation of U.S. patent application Ser. No. 15/683,650, filed Aug. 22, 2017, which application claims priority of U.S. Provisional Application No. 62/378,191, filed Aug. 22, 2016, the entire contents of which are hereby incorporated by reference.

### BACKGROUND OF THE INVENTION

The present invention relates to the field of modelling, analyzing and managing data networks.

Day-to-day operations of modern enterprises, government entities, network service providers, and other organizations rely on computer networks—for storing and retrieving data from databases, enabling communication between employees, and providing services to customers, among many other needs. However, these networks have become increasingly more complex, and network administrators are subject to pressure to adapt such networks to sometimes rapidly changing business needs. To a significant extent, network management activities are carried out manually. In a complex, changing network environment (sometimes with thousands of changes per month), human factors, as well as software bugs, can lead to critical errors. Such errors can result in outages, performance degradation, unauthorized intrusions, vulnerabilities that can lead to leakage of sensitive information, and many other problems.

One general approach to identifying such errors is to monitor data traffic as it flows through the network. Data packets' source and destination, header fields containing metadata, transit timing, transit path, and final disposition might be collected; or due to the high rate of data flow portions of such information for sample data flows may be collected. This traffic data may then be analyzed in an attempt to identify anomalies, such as service outages or exfiltration in a data breach. However, by its very nature of examining current or historical data packets, this traffic monitoring approach only raises alerts after problems are already being experienced by users of the network or security has already been breached.

Recently, the emerging field of network verification has applied logical reasoning processes analyze the correctness of data communication networks. Such network verification systems attempt to predict possible data flow behavior before it happens. This allows potential problems to be identified and corrected before they are experienced by users of the network.

In U.S. Pat. No. 9,225,601, the entire contents of which are hereby incorporated by reference, three of the present inventors described a network-wide verification system. The system may be adapted with a data plane verification layer positioned between a set of multiple network devices and a controller in network communication with the devices, where the controller is configured to transmit packet-forwarding rules to the devices. This system addresses methods and systems to integrate with software-defined network controllers and data structures to perform efficient, real-time verification, among other things.

What are needed are improved systems and methods for modelling, analyzing and managing data networks.

### SUMMARY OF THE INVENTION

The present invention provides systems for and methods of modelling, analyzing and managing data networks. In accordance with an embodiment, a system for managing a network is provided. A plurality of network device interfaces are configured to collect state information for a plurality of network devices. A computer-implemented model of the network comprises a data structure, which may be graph-based. The data structure comprises a plurality of snapshots of the network, each snapshot representing the network at a particular point in time, and the data structure comprises a representation of possible data flow and data packet processing within the network. The data structure contains normalized representations of the network devices corresponding to the location. The normalized representation for each device contains a set of packet processing rules. A user-interface is configured to receive queries from a user that request verification of network policies and predictions of network behavior. The user-interface is configured to display responses to the queries that are obtained using the data structure.

This and other embodiments are described herein.

### BRIEF DESCRIPTION OF THE DRAWINGS

The present invention is described with respect to particular exemplary embodiments thereof and reference is accordingly made to the drawings in which:

FIG. 1 illustrates a system for modelling, analyzing and managing a data communication network in accordance with an embodiment of the present invention;

FIG. 2 illustrates a system for modelling, analyzing and managing a data communication network in accordance with an alternative embodiment of the present invention

FIG. 3 a flow chart showing a method of network management in accordance with an embodiment of the present invention;

FIG. 4 illustrates a graph-based data structure of a network model in accordance with an embodiment of the present invention;

FIG. 5 illustrates a graphical user interface showing a graphical view of a network displayed in response to a search query in accordance with an embodiment of the present invention;

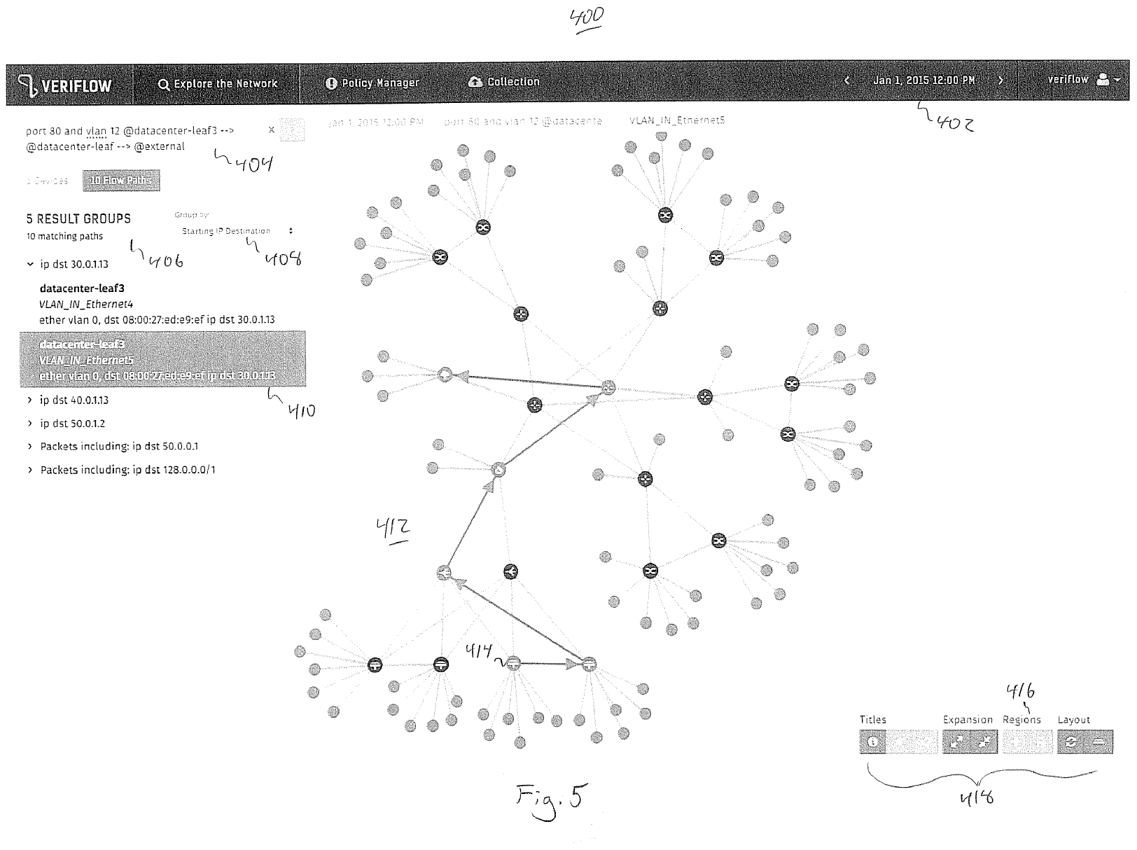

FIG. 6 illustrates a graphical user interface showing entry of query parameters to construct a policy (or intent rule) based on a template drawn from a library of intent rules, in accordance with an embodiment of the present invention;

FIG. 7 illustrates a graphical user interface showing a graphical view of a network displayed in response to a verification query for a particular policy in accordance with an embodiment of the present invention; and

FIG. 8 illustrates a computer system that can be used to execute network verification methods in accordance with an embodiment of the present invention.

### DETAILED DESCRIPTION OF A PREFERRED EMBODIMENT OF THE INVENTION

The present invention is directed toward systems for, and methods of, modelling, analyzing and managing data communication networks and behavior of data packets flowing through such networks. A data communication network includes multiple packet-processing network devices (also referred to as “objects”) including, but not limited to, routers, switches, firewalls, load balancers, data storage devices, data terminals, servers, special-purpose devices, and so forth. Such a data communication network also includes data communication links among the devices. The data communication links can be wired (e.g., Ethernet, USB, etc.), wireless (Wi-Fi, Bluetooth, radio, cellular, etc.) or a combination thereof and can perform communications in accordance with a variety of communication protocols (e.g., Ethernet, TCP/IP, etc.).

Network devices can be configurable according to various packet handling rules and policies as well as other operational parameters. Such network devices can be complex machines including, for example, controllers, software and/or firmware, internal communication buses and data storage including packet buffers, as well as storage for software that controls operation of the device.

For managing a network, personnel (e.g., network engineers, architects and systems administrators) need a broad understanding of the network. Thus, an effective, deployable, and usable system for modelling, analyzing and managing networks addresses a broad scope of challenges in terms of what is modeled, how the model can be queried, and how data is analyzed in order to produce useful results as well as confidence in the tools used. Embodiments of the present invention address some or all of these needs by providing several major components of a flexible network modelling and analysis system including: a flexible heterogeneous model of the network, including not only data flow behavior in a snapshot of the network, but also an array of properties of objects in the network and across time, and that employs appropriate algorithms and data structures (which can include multiple queryable datasets) so that the model can be efficiently queried; use of the network modelling system to model not only snapshots of actual network states, but hypothetical states; a powerful search language and system to query high- and low-level properties of the network model; analysis algorithms that utilize flexibility of the model to produce results and answer questions; and user interfaces that also utilize the flexibility of the model to provide visualizations that help provide documentation, insight, or diagnosis of problems.

Overview

In accordance with an embodiment, the present invention can be implemented within a network verification system, such as is described in U.S. Pat. No. 9,225,601, entitled “Network-Wide Verification of Invariants,” the entire content of which is hereby incorporated by reference. Particularly, a system in accordance with present invention may include a network verification layer positioned between a network controller and a network where the network includes network hardware devices that process and forward data packets such as routers, switches, hubs and the like.

The verification layer in accordance with the present invention may itself include a controller that is coupled to computer storage in which information is stored pertaining to the network and its management, as described herein. In an embodiment of the present invention, referred to as “Software-Defined Network (SDN) deployment mode,” the network controller is in communication with the network verification layer. In addition, the network controller may also be in network communication with a network device interface of the network and configured to transmit routing commands or packet-forwarding rules in real time to the network devices. In an alternative embodiment of the present invention, referred to as “non-SDN deployment mode,” the network controller may be omitted; in such an embodiment, the system collects network state information directly from network devices to construct a model of the network and the results of policy verifications may be used by the system to (a) configure or reconfigure devices within the network to eliminate the violation, (b) trigger an alert on an external network management or security monitoring system, (c) visually illustrate problems in the network to users of the system, and/or (d) either trigger an automated change to configurations or block such a change if policy verifications pass or fail.

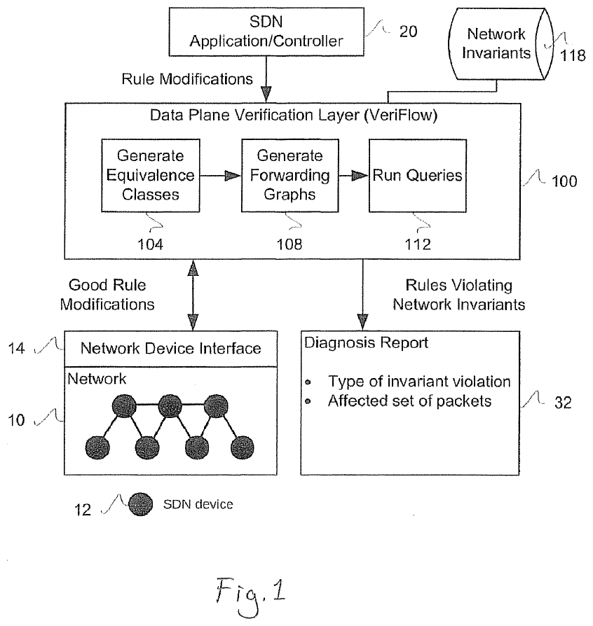

FIG. 1 illustrates a system for modelling, analyzing and managing a data network in accordance with an embodiment of the present invention. FIG. 1 illustrates an embodiment of the present invention in accordance with SDN deployment mode. As shown in FIG. 1, a network diagram is provided showing the interposition of a data plane verification layer 100 between a network controller 20 and forwarding devices 12 of a network 10. The data plane verification layer 100 (also referred to as “verification layer”) may be positioned between an application or network controller 20 and the network devices 12 that forward data packets such as routers, switches, hubs and the like. The network controller 20 may be in network communication with a network device interface 14 of the network 10 and configured to transmit routing commands or packet-forwarding rules in real time to the network devices 12. The verification layer 100 may be coupled with or include a controller and also computer storage 118 (which can be memory or mass storage) in which is stored network invariants or conditions that define proper network operation as well as other information.

The data plane verification layer 100 may therefore obtain rule modifications from the controller 20 and send the rule modifications for execution by network devices 12 impacted by the rule modifications, which can be after verifying proper operation of the network according to the network invariants if the rule modifications were to be sent to devices for adoption. A rule modification may include a new rule, the deletion of a rule, or a revision or update to an existing rule. If any of the rule modifications violate conditions or network invariants of the network, then a diagnosis report 32 may be generated that includes the type of invariant violation and a set of packets affected by the violation. An invariant may include a condition or state expected to be upheld in valid network operation as set by an operator or by third party controllers. For example, an invariant may include a condition regarding packet-forwarding behavior in the data plane of a network, where the packet-forwarding behavior is either true or false for a given network at a particular moment in time. The data plane verification layer 100 may perform various processing steps to perform verification, which may include but not be limited to generating equivalence classes (104), generating forwarding graphs (108) and running queries (112) or data traces to perform the verification on the forwarding graphs. These steps will be discussed in more detail below.

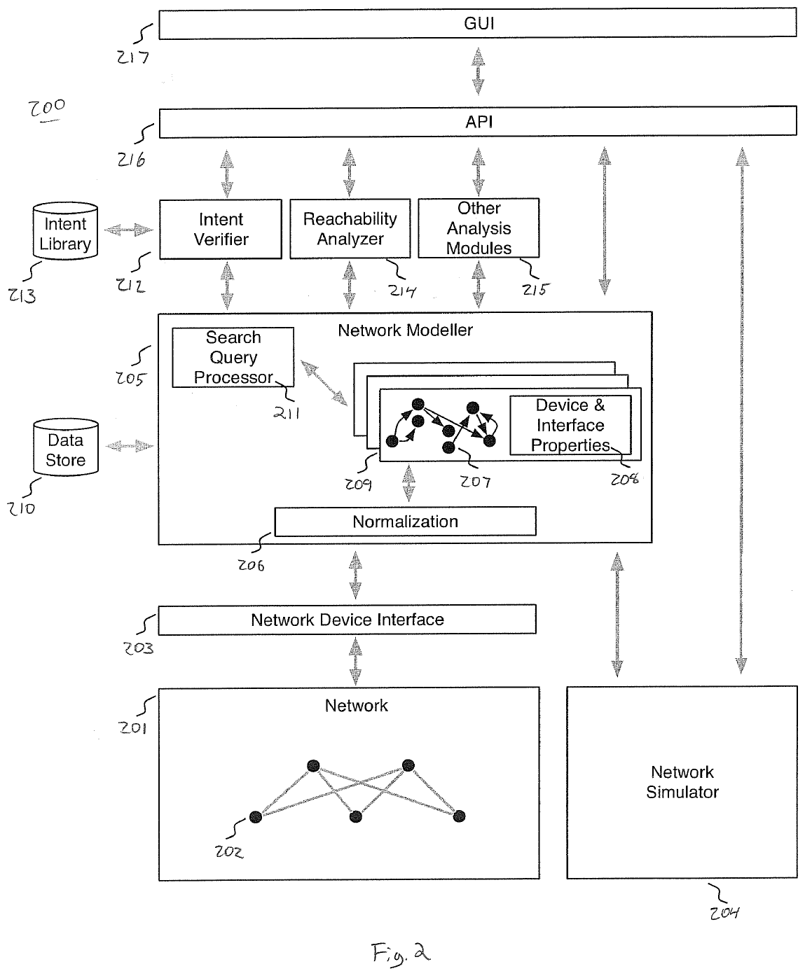

FIG. 2 illustrates an embodiment of the present invention in accordance with non-SDN deployment mode. The system 200 is in communication with a network 201 consisting of a plurality of network devices 202 (such as firewalls, routers, switches, virtual switches, etc.) via a network device interface 203. Device state information is extracted and sent to the network modeler 205. In addition, a network simulator 204 may produce hypothetical device state information, for example by simulating the effect of a configuration change prior to deployment, which is also sent to the network modeler 205. The network modeler 205 normalizes its input 206 to produce a single format across a plurality of device types or manufacturers. It produces a (real or hypothetical) snapshot of the network consisting of a graph-based model of potential data flow behavior 207 and a variety of attributes or properties of devices and interfaces or other objects in the network 208. The system may store a multiplicity of such snapshots 209 which are stored in a data store 210, which can be memory or mass storage. The system provides an interface and a search query processor 211 to query the network model to obtain objects and data flow behavior. Higher-level analysis modules may be built by querying the model, such as: an intent verifier 212 to verify whether intent matches the model, drawing on intent rules built from an intent library 213; a reachability analyzer 214; and potentially other modules 215. Verification and analysis models, the network modeler, and the network simulator may make their functionality available via an application programming interface (API) 216 which programs and scripts can access directly, and on which a graphical user interface 217 can be built.

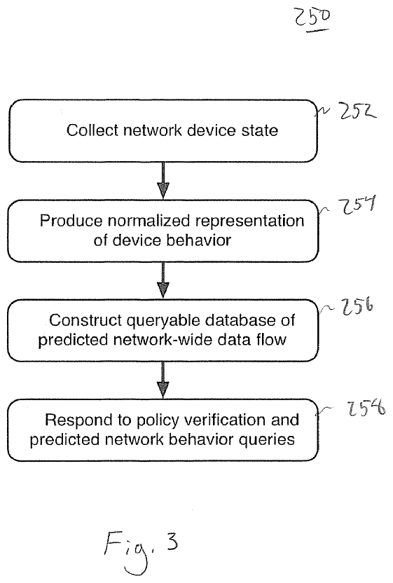

FIG. 3 illustrates a flow chart showing a method 250 of network management in accordance with an embodiment of the present invention. FIG. 3 illustrates an embodiment of the present invention in accordance with non-SDN deployment mode. As shown in FIG. 3, network device state is collected by the system in a step 252. Network invariants that are derived from a library or are custom-built invariants may also be received in step 252. A normalized representation of device behavior may be produced by the system in step 254. This normalized representation is produced based on the information obtained in 252. A queryable database of predicted network-wide data flow is then constructed by the system in step 256. This database is constructed using the normalized representations produced in step 254 and forms the basis of the model of network behavior.

In step 258, the system may respond to queries using the model. These queries can be, for example, requests for verification of policies identified in the queries and predictions of various network behaviors specified in the queries.

The verification layer 100 (FIG. 1) or the network modeler 205 (FIG. 2) may, for example, perform the steps of the method 250 of FIG. 3. The database may be stored, for example, in storage accessible to the verification layer (e.g., storage 118 or 210).

Building a Queryable Model of Predicted Network Behavior

The present invention employs a model which serves as a basis of network understanding and to which advanced querying and data analytics methods can be applied.

To begin with, the network verification system obtains data about network devices, and may do so by obtaining “data plane” state, e.g., as described in a prior disclosure (U.S. Pat. No. 9,225,601) or through other means. However, in addition to state information that affects packet forwarding behavior, the present invention obtains, uses, and stores additional attribute information about network devices. The data plane state, as used herein, may include device or interface state information that may be used to determine packet forwarding behavior, including but not limited to, IP forwarding tables, firewall rules, ARP tables, MAC address tables, MPLS forwarding tables, and other state information. The data plane state, as used herein, may also include device attributes that may not be directly used to determine packet forwarding behavior, including but not limited to, device manufacturer, device operating system types and/or versions, device memory size, time since the device has been rebooted, device name, and a variety of other device attributes. The data plane state may also incorporate a wide variety of attributes about network interfaces, including but not limited to network interface card operational status, interface error counts, such as counts of packet drops, counts of the number of malformed packet (CRC) errors on particular interfaces, bandwidth, maximum transmission unit (MTU) size, IP address, VLAN identifiers, and so on. In the case of both device and interface attributes, the possible attributes may be extensible dynamically, so when data is collected about the network it may be augmented with whatever information is available (which may vary from device to device). This obtaining of data about network devices can be performed in step 252 (FIG. 3).

Next, a representation of each individual device's behavior is produced. In one embodiment, the system may employ a single representation language or format which can accurately describe various device types (firewalls, switches, routers, load balancers, virtual switches, etc.) from various vendors; that is, a “normalized” format. One embodiment of this normalized format may contain sets of packet processing rules that may be arranged in multiple stages, where there may be a plurality of stages within a single device, and where each rule defines a condition under which a specified type of packet will be handled with a specified action or actions by the device, and where such actions may include modifying the packet, dropping the packet, or forwarding the packet to another device or to another stage within the same device. Each of the various device types may be translated to this normalized format in a way that accurately describes its functional packet-processing behavior. Generation of this normalized information can be performed in step 254 (FIG. 3).

The system may then reason about the entire behavior of the network together. The aforementioned prior disclosure demonstrated mechanisms for producing a “forwarding graph” representing all possible network-wide data flow behavior, and testing that behavior against a list of “invariants” (or policies) to be verified. A possible (or predicted) network data flow behavior may refer to the possibility of a particular kind of data flow or group of data flows, starting at a certain location (such as a server or switch port), and traversing a particular sequence of network devices and links, or stages within a device, before eventually being either dropped or delivered to a destination. An invariant (also referred to herein as an intent, intent rule, or policy) indicates which types of possible behaviors are considered correct by the network operator; for example, a policy may specify that “no packets at device A should be able to traverse the network and reach device B,” or that “all hosts in remote offices can reach both datacenters on TCP port 80.” In other words, such policies, invariants or intent rules are conditions that define intended network operation.

However, the needs of network operators in understanding their networks go beyond a fixed list of policies. Here, we describe a system that allows flexible and interactive exploration of network behavior and a broad scope of the network model. The verification system provides a flexible heterogeneous model of the network including not only data flow behavior in a snapshot of the network, but also a broad array of properties of objects in the network and multiple snapshots across time, and employs appropriate algorithms and data structures so it can be efficiently queried.

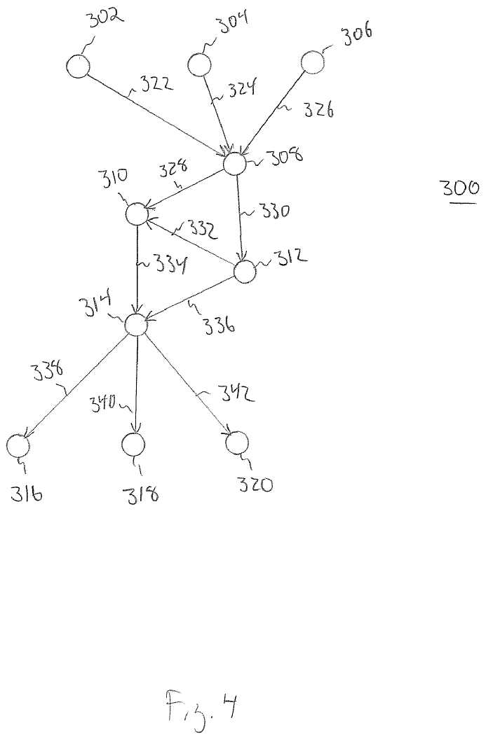

In order to provide a basis for this functionality, the network verification system may maintain a graph-based representation of possible network behavior. Such a data structure is also referred to herein as a forwarding graph. FIG. 4 illustrates an exemplary graph-based data structure 300 of a network model in accordance with an embodiment of the present invention. The data structure 300 includes a number of nodes, 302, 304, 306, 308, 310, 312, 314, 316, 318 and 320, as well as a number of links (or edges) 322, 324, 326, 328, 330, 332, 334, 336, 338, 340 and 342, interconnecting the nodes. The particular arrangement of the nodes and links corresponds to the configuration of the physical network being modeled. Each node, also referred to herein as a “forwarding node,” corresponds to network traffic (i.e. a set of packets) that experiences the same packet forwarding behavior at a particular location in the network. Locations in the network can correspond to any of a device, an interface, or a portion of a device. For example, where the device is a switch, a location can correspond to a particular port of the switch. As another example, a location can correspond to a packet processing stage within a device (i.e. a flow table within a device). Locations can also correspond to virtual or logical devices. Thus, multiple nodes can correspond to a single location and multiple locations can correspond to a single physical device. For each such node, the data structure 300 includes information about the node, including information about how the device or devices at that location processes packets, which can include any of the state information described herein in connection with the data plane state. The data structure 300 preferably also includes attributes, which can include any of the attributes described herein in connection with the data plane state.

Each link in the data structure 300, also referred to herein as a “forwarding edge,” corresponds to a forwarding action applied to the set of packets at a node. Such edges correspond to physical communication links within the network. The edges can also correspond to forwarding actions within a device (e.g. moving a packet from a port buffer to another port buffer). Each node can have multiple outgoing edges (e.g., for load balancing and other types of redundancy).

The data structure 300 can represent behavior of the physical network at particular point in time (referred to as a “snapshot”). The data structure 300 can be stored in the data storage 118 (FIG. 1) or 210 (FIG. 2).

The information stored in connection with a snapshot may also include information about devices in the network including any device or interface state information or device or interface attributes of the data plane state as described herein. In addition to a snapshot, the system may store (e.g., in data storage 118 or 210) a collection of multiple snapshots of behavior over time.

Further enhancing the breadth of data stored about the network beyond only predicted data flow, the system may allow grouping of devices into a hierarchy. More specifically, the system may define this hierarchy in terms of groupings called “regions.” A region can be created by the user or through an API, and has an associated name and contents. The contents are a list of objects defined to be within the region, which may include devices or other regions. If a region R1 contains a region R2, then R1 is said to be R2's parent. Each region is only allowed to have a single parent, and a region may never be placed within another region if this would create a circular chain of ancestors. A parent/child relationship may optionally be scoped to apply only to a certain time range of snapshots or specific snapshots of the network.

Still further enhancing the breadth of data stored about the network beyond predicted data flow, the system may allow “tagging” of any object stored in its database, such as devices, network interface cards, and regions. A tag may be an arbitrary string chosen by the user. The system may permit each object to have a list of associated tags. Tags may be manually assigned, or culled automatically from an external source such as a database of assets in the enterprise or a software-defined network (SDN) controller. For example, an SDN controller may be aware of the association between virtual machines (VMs) and an application like a web service, and a tag such as “Web Service” may be associated with each such VM. A tag may optionally be scoped to apply only to a certain time range of snapshots or specific snapshots of the network. The tags can also be stored in data storage (e.g., 118 of FIG. 1 or 210 of FIG. 2) and used in queries for searching for and identifying devices having specified tags.

The network verification system may also construct and maintain one or more indexes to enable efficient lookup of objects (devices, interfaces, locations, etc.) and data flow behavior that matches a particular query of interest to the user. This collection of mechanisms can provide a fully searchable model of all possible data flows and device state in the network. Different indexing methods may be used on different types of data. For example, a hash table may be employed to map device manufacturer names like “NetworkingCo” to a list of devices manufactured by the company NetworkingCo. To index data flow behavior (represented by forwarding nodes at various locations), the system may provide a data structure which permits (1) adding a packet set paired with an associated object (forwarding node or forwarding rule) to the data structure, (2) removing such (packet set, object) pairs, or (3) given a query packet set Q, finding previously added objects whose associated packet set intersects Q. To implement such a data structure, the system may employ a trie in multiplicity to index forwarding nodes at multiple particular locations in the network. Alternately, to implement such a data structure, the system may store a hash table which groups the added packet sets according to intersection with a particular field—such as a VLAN identifier; when presented with a query packet set Q, the system can determine which VLAN identifiers are present within Q, and look each of these up within the hash table. Such additional data structures, including indexes and trie structures, can also be stored in the data storage (e.g., 118 of FIG. 1 or 210 of FIG. 2).

In some cases, a search may scan all objects or a subset of objects one-by-one to find those that match a query, in order to conserve space that would otherwise be occupied by an index. Alternately, the system may employ one or more external or additional databases such as SQL or NoSQL databases to store and query certain aspects of the data like device names, models, quantitative statistics, etc., while simultaneously employing custom storage and indexing of forwarding nodes (as described above) which is not directly supported by such external or additional databases. Such external or additional databases can be, for example, stored in the data storage 118 or some other accessible location.

All such information may be stored not just for a single snapshot but for multiple snapshots, so that queries of one or more device or data flow properties can be performed at a specific time, or across time. As the system stores more snapshots, limited memory can be of concern. Thus, the system may employ caching of recently-queried data with less-recently accessed data being stored in mass storage, such as a disk drive or disk array. The system can compress representations of data by storing time ranges during which a particular device property or data flow behavior remains unchanged (rather than storing the same piece of data repeatedly across many snapshots).

Generation of this data structure and associated information can be performed in step 256 (FIG. 3).

Interactive Policy Verification and Search in the Predictive Model

With this specialized database of network state and predicted data flow behavior in place, the network verification system may verify user-generated policies on-demand (e.g., as in step 258 of FIG. 3). Such policies may be verified interactively and in real-time (i.e. at the time they are proposed by the user), as opposed to verifying the policies only when placed in a pre-defined list, and may be evaluated on historical as well as current models of the network. The ability to verify such policies may be provided through an application programming interface (API) or through a graphical user interface.

In addition to verifying policies as correct or incorrect, the network verification system may provide access to query its database of network state and predicted data flow behavior. Unlike tools that only reason about individual devices, the network verification system preferably supports queries on not just network element attributes, but on the behavior of the entire network, and combinations of data flow and network elements. For example, a user may ask the verification system questions, such as: “Can any of my private VLANs leak onto one another?”; or “Are any of my host-facing ports vulnerable to rogue DHCP servers?” The questions can preferably be expressed at a high level, allowing operators to express intent, rather than working with the complex and error-prone low-level details of implementation.

To facilitate these queries, the network verification system may provide a flexible format to specify a query that requests retrieval of predicted network behavior subject to user-specified constraints. These constraints may describe the type of data flow traffic of interest, as well as the kind of paths through the network. These paths may be written in a regular-expression based format to describe network object sequences, allowing highly diverse and customizable representations. In particular, network element sequences in the network verification system may be composed of a sequence of atoms. Each atom may either describe an object in the network, or may be an operator.

Some atoms specify constraints on locations, and these can be joined by Boolean operators. A “location” refers to a network location or set of locations to be matched—a physical or logical element of the network such as a device, network interface card, or a virtual interface, or a set of any such objects. Both regions and tags may be referenced as location specifiers in search query strings. This location may be itself specified as a query that matches certain locations based on attributes such as those mentioned above (e.g., a query matching a certain device manufacturer, or matching devices with at least 100 recent packet drops, and so on; or any Boolean combination of such constraints). These objects may be combined by operators, including regular expression operators (Boolean, grouping, quantification, set negation “A”, etc.).

To search for data flow (rather than only objects), we introduce other operators and substrings. In the query string taking the form “traffic @ location”, “traffic” describes packet header constraints and “location” refers to a network location or set of locations to be matched (as specified above). These traffic/location combinations can be joined with various operators, such as: an operator expressing reachability between network elements across one or more hops (“-->”), an operator expressing reachability between network elements across exactly one hop (“->”), an operator representing a reply sent by a host so that the remaining path must “turn around” and exit from the previous termination point (“=>”), and so on.

As an example, a fully-formed query string that searches for certain devices in the network may be as follows:

“device: device. manufacturer(NetworkingCo) and device. uptime. greater_than(1 year)”
This requests retrieval of devices which are manufactured by NetworkingCo and have been running for more than a year.

An example query string that searches for data flow paths in the network may be as follows:

“port 80 @device. manufacturer(NetworkingCo) and device. uptime. greater_than(1 year)-->@device. type(firewall)-->@device. name(datacenter)”
which would ask the network verification system to retrieve possible data flow behaviors in which possible traffic with TCP port 80 begins at any device manufactured by NetworkingCo that has been running for more than a year, passes through a sequence of zero or more intermediate devices, reaches a firewall, passes through another sequence of zero or more intermediate devices, and finally reaches any device with “datacenter” in its name.

Such queries may be issued to the network verification system through an API, or through a graphical user interface. In either case, the queries may return a list of possible data flow behavior or objects in the network matching the constraints of the query string. FIG. 4 illustrates a graphical user interface 400 showing a graphical view of a network displayed in response to a search query in accordance with an embodiment of the present invention. More particularly, FIG. 4 depicts a screenshot where a user has issued a search query through a graphical user interface and one resulting data flow behavior matching the query string constraints is selected and illustrated in a graphical view of the network. As shown in FIG. 4, a field 402 shows that the user has selected a particular snapshot of the network to query and explore, identified here by a time stamp (Jan. 1, 2015, 12:00 pm). Thus, this can be an historical snapshot of the network. A query field 404 allows the user to enter a search query. The query uses a query format which asks to search for behavior of a particular class of traffic (e.g., on TCP port 80 and VLAN identifier 12), starting at “datacenter-leaf3”, passing at some point through “datacenter-leaf”, and eventually reaching “external”. The query employs an operator “-->” to indicate zero or more intervening steps that may pass through any location. Each of those last three location specifiers may be used by the search function to find matching devices by searching various information within the database. In this case, “datacenter-leaf3” may, for example, match an exact device name, “datacenter-leaf” may be a partial match to multiple devices, and “internet” may match a tag associated with an interface.

Also shown in FIG. 4 is a results field 406 which indicates that the system has discovered ten paths that match the search. A “group by” field 408 shows that the user has requested that results be placed in groups where each group has the same set of IP destination addresses at the start of the path. The system displays a result group as a list of paths that satisfy the query. Here, the user has selected a specific path 410 from within a result group, all of which have a single IP destination address 30.0.1.13. In a display area 412, a topology of the physical network is shown. Certain aspects of the visualization may employ heterogeneous features of the network model; for example, throughout the display area 412 of FIG. 4, device icons indicate the type or function of the device (load balancer, firewall, router, etc.). Within the display area 412, a physical location 414 traversed by the selected path 410 is highlighted in the visualization of the network (e.g. by being depicted in a different color from other elements of the network). The user interface provides functions to modify the model of the network, including by adding a “region” and grouping devices into that region. FIG. 4 shows a “regions” button 416 among an options menu 418, though results of such a grouping are not shown.

We next describe how such a search function may be implemented within the previously described queryable model of the network. To begin with, the query string is first parsed into aforementioned atoms, which encode desired constraints on the forwarding paths or objects of interest. An abstract syntax tree (AST) may be used to organize the sequence of atoms to show the precedence of the operators. In particular, each of the aforementioned traffic descriptors may be first converted into a sub-syntax tree, and then into a data structure representation of device or interface properties and packet sets (that is, a packet set data structure represents a set of packets like “all packets whose TCP port field is 80”). The location descriptors may be resolved into a set of physical or logical network elements by querying the network model database. For instance, a location descriptor “device.type(firewall)” may be translated into the set of devices which are firewalls using a query to the model's index of devices by type; and a descriptor “action(drop)” may be resolved into the set of forwarding edges where a certain type of packet-processing function (in this case a drop action) takes place. In the case of an object search query (such as in the first example above), this is sufficient to resolve the query's results.

In the case of a query for possible data flow, additional steps may be needed to find paths within the forwarding graph. Such steps are described as follows. The sequence of atoms may be compiled into a state machine equivalent to the regular expression. For example, a nondeterministic finite automaton (NFA) may be built using an algorithm based on Thompson's construction. The NFA for a query is built up from partial NFAs for each subexpression (atom), with a different construction for each operator (concatenation, alternation, grouping, etc.). Note that a reachability operator like “-->” may need special care, because one reachability operator can correspond to a combination of states in the NFA. They may be first expanded into a sequence of atoms internally, and then translated into a partial NFA.

After converting the regular-expression query into a state machine, the system can determine whether there are paths satisfying the query in the graph-based representation of all possible network behaviors. Using the graph database as input, the set of paths that satisfy the query may be retrieved by traversing the graph guided by the state machine. The traversal starts at the graph nodes that match the start state of the state machine. From then on, the traversal continues if the next hop nodes of the current graph node match any of the directly reachable states in the state machine. The process may be continued in a depth-first search manner, until the end of the graph exploration.

The above queries have been described without reference to time, as if there is an assumed particular snapshot of the network. These queries can be augmented with a specification of that snapshot (as a timestamp or an identifier of the snapshot), or could specify a range of time period across which to query.

In general, the syntax of search queries described here is provided only as an example, and many other variants or even very different query formats are possible. For example, queries could be represented with different names and characters for operators, with an API using data structures rather than a string, with a declarative logic programming language like Datalog, or with components of an SQL-like language to represent location queries. All these approaches could achieve the goal of being able to query data flow behavior and device/interface properties (both individually and jointly) at specified times or time periods.

The result of the above queries depends on the type of the query and may be a set of zero or more matching (1) devices, (2) interfaces within devices, (3) data flow behaviors. This “data flow behavior” may be represented by a subgraph of the overall forwarding graph representing the entire network's data flow behavior described above. In one special case, such a forwarding subgraph may be a single path from a source through intermediate locations to a destination; however, a single result may contain a subgraph that has more than just a single path, if for example the data may potentially flow along multiple paths due to a load balancer spreading traffic along multiple paths.

For all result types, the system may provide the capability to sort and group results. For example, in a search for devices, results could be sorted alphabetically by device name, reverse-numerically by uptime, number of attached interfaces, and so on for any other property stored concerning the device. Devices could be grouped by manufacturer, tag, region, etc. In a search for data flow, results could be grouped or sorted by:
1. Distinct path (e.g., two results that involve different packet sets but the same physical path would be grouped together)
2. Starting location or ending location
3. Fate (i. e. results would be grouped by the last action occurring to traffic: dropped, delivered, forwarded outside the scope of the model, or looped indefinitely)
4. Contents of fields in the packet set at the start of the result (e.g., IP prefix, VLAN, etc.)
5. Contents of fields in the packet set at the last hop of the result (e.g., IP prefix, VLAN, etc.).

Grouping and sorting may further be applied at multiple levels, so queries may for example request grouping by path, and within each path group, by VLAN. Sorting and grouping may be executed by (1) running queries as described previously to obtain a set of results, and then (2) applying a sorting algorithm to a particular attribute of the results, or grouping results by that attribute. However, grouping executed in that manner has a disadvantage: if stage (1) returns only a subset of all possible results, for example, if the set of all results is too large, then stage (2) will present the user with an incomplete list of groups. The result may be confusing for a user; for example, when searching for results grouped by fate, the results may include only “delivered” results, giving the impression that all traffic is delivered to a destination even though some may be dropped. Therefore, grouping may be additionally executed in another way to produce more helpful results: in step (1), the system can first determine a set of possible groups, and then search to include some results within each group (if any exist) before continuing to step (2).

Modelling “Pre-Deployment” Network Changes Prior to Deployment

Furthering the goal of building a flexible platform for understanding the network is to use the network modelling system to model not only snapshots of actual network state, but a hypothetical state (also referred to as a “pre-deployment state”), which can be included in the multiple datasets queryable in the network modelling system.

In particular, consider a user who would like to verify a hypothetical network that would exist after they have made a change to a configuration. The goal is to verify outcomes and take remedial action prior to deploying a change to devices. We refer to this capability as “pre-deployment modelling” or “pre-deployment verification.”

In other words, in typical operation of a real network:
An updated configuration is given to network devices.
Network devices and their software collectively run protocols that compute a data plane state.
The data plane state is used by switching hardware to determine data flow.

In pre-deployment verification, a process may be followed such as:
An updated configuration is provided to the network modelling and verification system, e.g., by a user.
The system determines (e.g., through simulation) how the changed configuration will affect data plane state.
The system can verify properties within the hypothetical pre-deployment model and perform other visualization and analytics.
If the pre-deployment model passes automated or manual inspection, the updated configurations can be (manually or automatically) passed to network devices.

A feature of the network model can be to incorporate both pre-deployment snapshots as well as live snapshots from the actual network, in order to perform joint analysis. As we will see, this capability is valuable both to produce an accurate pre-deployment model, as well as to analyze that model.

The step of determining how the changed configuration will affect data plane state in the above workflow involves predicting what the network devices (which may have millions of lines of control software) will do. Thus, the effect of a changed configuration can be difficult to determine. There are a number of ways to accomplish this:
Given modified configurations, the system may simulate the standard operation of relevant protocols like BGP, OSPF, MPLS, etc. At the outcome of the simulation, the final (simulated) data plane state can then be modeled as would a snapshot of the live network. This outcome is expected to mimic the resulting data plane state that would be produced if the modified configurations were installed on devices.
A software emulation of all or some of the network devices may be carried out, whereby software-based devices similar to the actual deployed devices are run in a “virtual” environment.
A software emulation of all or some of the network devices may be carried out, whereby the exact executable code of the device (whether in a virtual machine or a software router in a container or something else) or software routers similar to the actual deploy devices are run in a “virtual” emulated environment. This emulation could be performed in a cloud computing environment to address potentially significant computational needs.
The system may be modified to accept changes in an abstract model of the data plane state, rather than modifications to configurations. This avoids the need to infer how the configurations will affect the data plane state, because the user directly informs the system of these changes. The changes may be specified in an abstract, vendor-independent representation of the data plane state, which allows the network operator to more quickly test changes that are not tied to a particular vendor.

In each of the aforementioned ways of determining how the changed configuration will affect data plane state, the modified configurations can be deployed on these emulated devices, and the data plane state that results can be observed after the emulation runs and provided to the network modelling and verification system. Regardless of how configurations are translated to the resulting data plane state (whether any of those listed above or other techniques), we refer herein to such a translation process as a “simulation” and to any module that performs such translation as a “simulator.”

A key challenge with each of the methods above is that for one reason or another, the simulation's predicted data plane state may not match the reality of the deployed network. To improve accuracy and catch problems, the system can make use of the capability to incorporate both hypothetical and actual snapshots of the network and to jointly analyze them. This can be accomplished as follows:

In the pre-deployment snapshot, missing elements of the data plane state can be supplied as follows. When simulating how the configurations produce data plane state, parts of the data plane state may be difficult or impossible to produce for numerous reasons. For example, details of the topology (like the number of interfaces on a device, or how devices are connected to each other, or which interfaces are up or down) may not be apparent from the configuration alone; MAC addresses of hosts stored in tables on the device may be absent from the configuration; BGP routes may be injected into the live network by neighboring autonomous systems outside the scope of the administrator's control, which do not appear in the configuration; or the behavior of one of the numerous possible distributed control protocols may not yet be supported by a simulator module. In this case, the simulator (or emulator) can combine information from a live snapshot with the simulation in one or more of the following steps in order to create a more complete or more accurate pre-deployment model:

(1) obtain certain elements of the live snapshot (e.g., physical topology, neighbors' BGP route advertisements) to use as input to the simulator;

(2) run the simulation to produce certain parts of the data plane state in a “draft” pre-deployment snapshot;

(3) examine which aspects of the data plane state are missing in the draft pre-deployment snapshot compared with an existing snapshot of the live network;

(4) copy those elements of the live snapshot into the draft pre-deployment snapshot to create a final pre-deployment snapshot.

Accuracy of the simulator for a particular network can be empirically determined. To perform this, the system (1) begins with a particular snapshot of the live network including both configurations and data plane state, which we will refer to as the base snapshot B, (2) runs the simulator starting with the actual unmodified configurations from B, rather than a modified configuration, (3) optionally applies elements of the approach described above for supplying missing elements to add parts of the state that are outside the scope of the capabilities of the simulator (or emulator), (4) obtains the resulting pre-deployment snapshot P and cross-checks it in multiple aspects (devices, forwarding rules, etc.) with the state of B. If the simulator is accurate, then P should match B. This comparison can be used, for example, in the following ways:

The degree of consistency can provide an empirical confidence score about the overall accuracy of the simulator (or emulator), or about aspects of the network where it is accurate or inaccurate. This analysis may be repeated across time for a more reliable score of the simulator's average accuracy.

Any discrepancies in the comparison between P and B may indicate either an inaccuracy in the prediction, a bug in the network device software so that its behavior does not match standard protocol specifications, or an error in device data collection. These cases can result in an alarm to the user or the manufacturer of the verification software, or statistics can be measured across time.

Analysis of the Model

The system described thus far provides a rich, heterogeneous, and queryable network modelling system. Those capabilities enable more advanced analysis of the model in order to produce useful information. We describe here several key capabilities.

Network Differencing

Network differencing, or simply “diffing”, answers a question: What changed? Even if a network engineer has the ability to use a verification system to test specific intent rules which can indicate correct or incorrect behavior, diffing provides a useful tool for analyzing the network. For example, network engineers may want to:
Obtain a quick overview to see if changes are roughly as expected in a pre-deployment snapshot compared with the live network—or in a pre-deployment snapshot compared with an earlier pre-deployment snapshot.
Determine when a currently-failing intent rule was most recently passing, and inspect other differences in the network between those timepoints (e.g., configuration changes) which may be the root cause of the failure.
Verify intent rules that depend on a diff rather than on only a single snapshot. For example, a network architect may desire that intent rules similar to the following are preserved:
“There are no changes in access control rules on data flow paths between interfaces configured as ‘access interfaces’ and the public Internet compared with a ‘golden master’ snapshot on Jan. 1, 2017.”
“Between a snapshot before and after a software update to routers, there is no change at all in data flow behavior.”
“After changing routing configuration for a certain IP prefix, there are no changes to routes outside that prefix.”
“At most 5% of the devices in the network have been added or removed since yesterday.”

In general, the user can determine if changes are within the bounds of expectations. These examples illustrate the value of automatically determining differences across arbitrary points in time, across live snapshots and pre-deployment snapshots, and across potentially any components of the network model (devices and interfaces and their associated properties, flows, regions, tags, intents, intent verification results, etc.), using many of the heterogeneous elements of the network model described above. Diffing can be performed in several ways:

Whole-network diffing: Each corresponding element of the model in two snapshots S1, S2 of the network are compared. This may be performed by

(1) iterating over each element of one of the snapshots and for each element, finding the corresponding element in S2, by matching identifiers, device names, etc., as appropriate; outputting a “deleted” result if the corresponding element is missing or a “modified” result if it is present but changed in some way in S2.

(2) iterating over each element of the other snapshot S2, and for each element, finding the corresponding element in S1 as above, and outputting an “added” result if the corresponding element is missing in S1.

The result of this process is a list of differences annotated as additions, modifications, or deletions.

Summarized diffing: After performing a whole-network diff, the system may summarize quantitatively the degree of change in groupings of elements (e.g., a region of the network, a kind of change like routing table entries, etc.), providing the option to explore the details.

Search diffing: Any query to the model may be employed in a diff mode, wherein it is queried on two snapshots, and the results of these queries are compared following the procedure above to produce a list of added/modified/removed elements.

Flow diffing: The system may adopt more specialized behavior for the case of a diff query to the data flow model (i.e. the forwarding graph). In one mode, the system may find any difference in flow behavior, such as a changed route. In another mode, the system may define a difference as a difference in end-to-end behavior of packets in one dataplane snapshot of a network compared to another. In this context, end-to-end behavior is defined as follows: Let D be any location in the network where packets originate. D can, for example, be a port on the top-of-the-rack switch in a datacenter. End-to-end behavior of packets starting from D is a set of pairs, where each pair consists of a final fate (such as dropped, consumed at switch S, etc.), and the set of packets that reach that final fate. To compute the flow diff, we first obtain the end-to-end behavior of packets from the same location in the two dataplane snapshots, and then compare the individual pairs to determine difference in final fate of those packets. For example, if traffic is rerouted but ends up in the same place in both snapshots, this is considered equivalent; if a particular set of packets at a single starting location is delivered in one snapshot but dropped in the other, this constitutes a difference.

Optimized flow diffing: Performance optimizations may be applied to the preceding functionality. For example:
While comparing a large number of locations that route packets through a common table of data plane rules, diffing can be done in two phases:
Phase 1: In the first phase, the system may compute the flow diff with respect to a packet processing stage which is common to many starting points in the sense that these starting points' traffic must pass through that packet processing stage. For a layer-3 routing device with many interfaces, the common flow table is typically the L3 table, through which all interfaces route their traffic.
Phase 2: If a diff is found in the first phase, the system may prepend to the diff paths leading from the starting locations to the common flow table. If no diff is found in the first phase, then the diff is computed over the starting locations, treating the common flow table as the last portion of the path that needs to be inspected for differences.

Heuristics can be used to determine what starting locations to compare in the diffing process. A good heuristic for this is the forwarding rule-level diff between the two snapshots. For example, if a device's routing table entry for a particular IP prefix like 10.0.0.0/24 has changed, the system may begin at that location in the forwarding graph and perform a forward and backward trace from that point to find candidate differences. It should be noted that a difference in rules need not necessarily imply a difference in end-to-end behavior.

Intent Library

Verification of intent (or policy) is an important use of the network model. The network verification system may assist the user in defining policies to be verified. The system may include a library of policy templates. These templates may be grouped into “packs” to accomplish specific high-level policy verification goals, such as Payment Card Industry Data Security Standard (PCI DSS) compliance of the network, or resilience against outage within a data center network, with each policy in the pack contributing a step towards the high-level goal. Each individual policy template may be designed to verify a certain policy with certain parameters supplied by the user.

For example, a network segment isolation policy may allow for two parameters—a starting segment of the network, defined by an object search query string, and an ending segment defined in a similar way. Once these parameters are filled in, the policy would specify that the starting segment is fully isolated from the ending segment, i.e., the range of predicted data flow behavior in the network does not permit packets to pass from the starting segment to the ending segment. Intent or policy verification refers to the system verifying that the network or a specified portion thereof (e.g., as represented by a particular snapshot), satisfies the applicable policies. In other words, intent verification determines whether the network operates as intended.

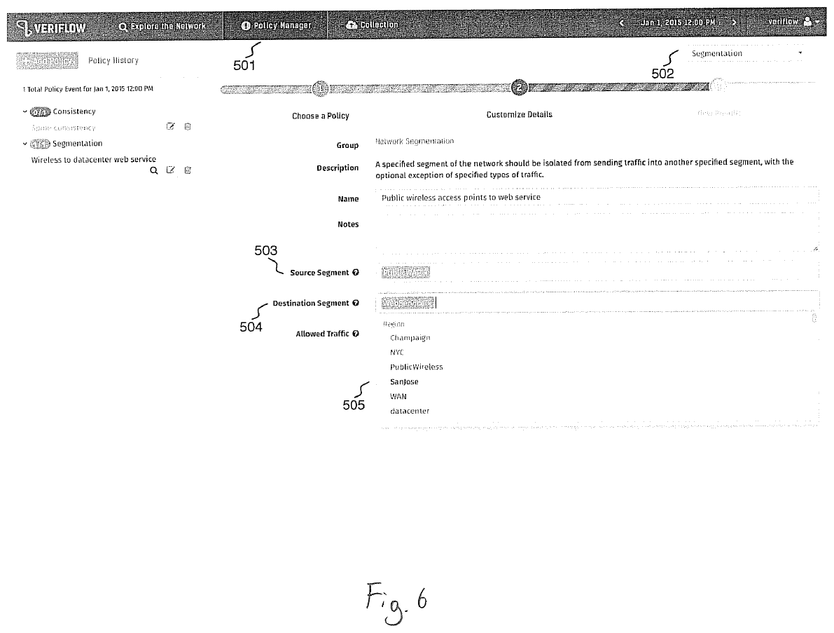

The system may include a graphical interface to allow users to interactively select a policy template, enter parameters, and request that the system verify the resulting policy in a historical or current network model. FIG. 6 depicts a screenshot of one embodiment of the network verification system with such a graphical user interface, where a user is in the process of entering parameters into a network segmentation policy template, using tags to define each segment. FIG. 6 shows a user interface that may be used with the system to utilize a policy or intent library. The user has selected the policy manager 501 in order to create a new policy, beginning with a network segmentation policy template 502. The user fills out policy parameters including the source segment 503 set as “PublicWAP” and the destination segment 504 set as “Web Service”. Here, the user has specified both parameters as tags, so that the meaning of the segmentation policy is that no device or interface tagged with “PublicWAP” should be able to send any traffic to a device or interface tagged with “Web Service”. The user might alternately have specified a segment in terms of a region 505.

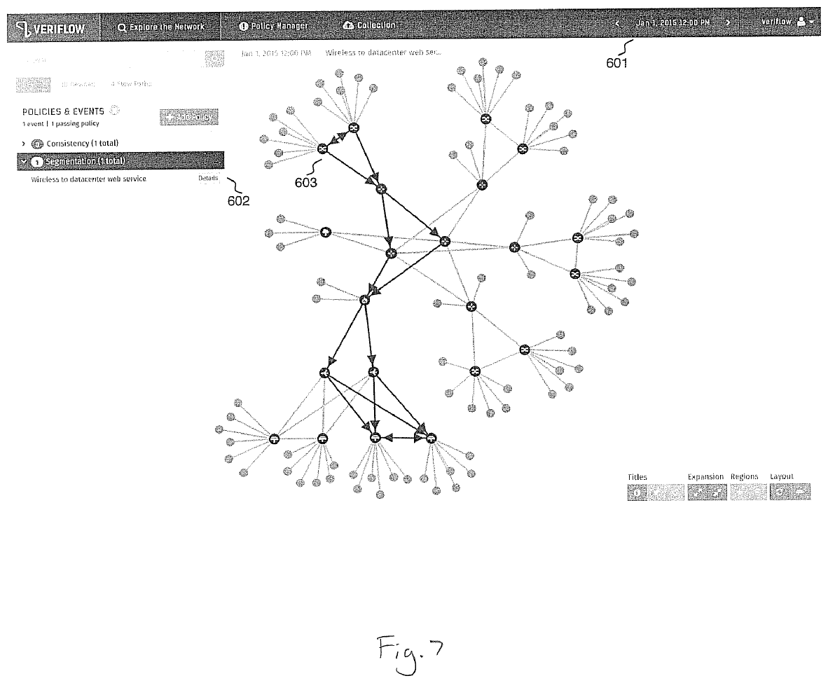

FIG. 7 depicts the verification system's mathematically verified result of the policy, which reveals a violation of the policy, illustrating the path along which violating traffic is predicted to be able to flow. FIG. 7 shows a user interface that may be used with the system to view and explore the result of a policy verification. The user has selected a particular snapshot in time 601 and within that. A particular segmentation policy 602 is shown in red because the policy was found to be violated, and example violations are illustrated 603.

Reachability Analysis

The system may analyze the model to summarize reachability, i.e., the ability of different starting locations to transmit various types of traffic to various destinations. Reachability can be crucial in a network, and summarizing it (1) may provide useful insight to the user if this summary is conveyed in a graphical form, and (2) may provide a more compact representation on which to perform subsequent analysis, because intermediate steps between source and destination have been eliminated. A challenge in providing this functionality is that different users or analysis applications may require reachability to be summarized in different ways. For example, in some instances a user may be interested in which applications are reachable, identified by layer 4 transport port numbers. In other instances a user may be interested in reachability between locations regardless of the type of traffic, e.g., for security purposes.

The system may therefore provide the capability to compute a summary of reachability using queries to the model, as follows:
To begin, the user or an external application supplies a source query and a destination query. This may employ the aforementioned search query capability to specify types of packets and locations. For example, the user may specify a source of “@boston” and a destination of “port 80 @ datacenter” to request a summary of reachability from any device in the Boston office to the HTTP service (indicated by port 80) located anywhere in the data center. Either or both of source and destination may be omitted, meaning the analysis is performed from all sources or to all destinations. In addition, a single snapshot or a range of snapshot times is specified for the query.
To indicate how to summarize the results, the user or external application supplies a grouping specification for the traffic sources, and a grouping specification for the traffic destinations. The system may support any of the grouping parameters discussed earlier for search queries, or other groupings, such as grouping by time when the analysis spans snapshots. As another example, the user may group sources by physical device, and destinations by VLAN identifier.
The system performs queries to determine the reachability. The result is a matrix. Each row of this matrix would correspond to a particular group among the source query; each column is a group among the destination query. The cell at position (row R, column C) would indicate whether the group corresponding to R can transmit data to the group corresponding to C. The cell may take on result values that may include representations of “no packets reachable”, “some packets reachable”, or “all packets reachable.” The system can determine the correct value with one or more queries to the network model. These results may be presented in machine-readable form, or visually in a matrix, for example with cells colored red, yellow, or green.
The system may analyze or cluster the rows and/or columns of the matrix by similarity, and use this to sort the rows or columns. This may allow the user to visually identify anomalous cells.

Graphical User Interface

A graphical user interface (GUI) associated with the network verification system may display both regions and tags in a graphical view of the network, showing the hierarchical grouping of devices into regions, and annotating (via color or text) the devices associated with a specific tag.

The GUI may display a map of the network showing devices and interconnections (links) between devices. Utilizing the heterogeneous elements of the network model, this map may be annotated with information about devices and their links, such as manufacturers, models, uptime, high CPU load, and so on. In general, the richness of the model may make it difficult to display all information at once. Therefore, the system may provide the capability to select “overlays” to place on the map. Each overlay, when switched on, may provide an annotation, coloring, or labeling of objects in the map with a certain kind of data, such as:

General details about the device (model, manufacturer, uptime, etc.)

Interface utilization metrics

Interface packet errors

Intent verification failures involving the device

Either the default view or individual layers may show increasing amounts of detailed information as the user zooms in to an area of the network. For example,
In a default view: when zoomed out, the system may show only the names of regions. As the user progressively zooms in, the system may show device names, followed by device models, followed by information about specific interfaces such as their name and IP addresses.
When showing an interface packet errors overlay: when zoomed out, the system may indicate devices with a high rate of errors by highlighting them in red; when the user zooms in, the system may list specific counts of particular kinds of errors (packet drop, CRC errors, etc.) for particular interfaces.

The system may also visualize how data flows through the network. For example, when showing results of an interactive search, the system may show a list of paths and when one is selected, it may show a detailed trace of how data flows along the path, including: each device along the path, the steps of processing within each device's internal packet processing pipeline, a description of the set of packets that exhibits this behavior, and how the packets are transformed. The system may provide a means of querying why each behavior along the path occurs, showing the data plane state that indicates this behavior. Furthermore, this path-oriented view of the network can be similarly annotated with overlays of information regarding devices and interfaces, as described above. For example, the system may provide an overlay that annotates both the network and a specific path with an indication of anomalies (e.g., intent verification errors, CRC errors, etc.) along the path.

Workflow Integration

The network verification system may include mechanisms to integrate into the daily workflow of network and security engineers. These mechanisms may allow the engineer to perform continuous verification of the network, during the process of making changes to network devices or device configurations. In particular, in one mode of operation, the user of the system is expected to make a change to the network, and subsequently verify the correctness of the results of this verification, taking remedial action if necessary. To support this mode, the verification system may include mechanisms to gather and verify network state after automatically noticing that a change has occurred, e.g., with Simple Network Management Protocol (SNMP) “traps” which are triggered on changes. The system may also include a mechanism for the user to explicitly request that the system verify the network immediately.

In a second mode of operation, the user is expected to propose a candidate change to the network verification system before that change is effected in the network. The verification system uses the “pre-deployment” capability described above to model this proposed change. The system may include an option to assist in management of the network with automated deployment of changes. In this case, the system (1) receives modified configurations from a user, (2) builds the pre-deployment snapshot as discussed above, (3) verifies a predefined set of intents within the pre-deployment snapshot; then, (4) if all intents are satisfied, the configuration change can be automatically deployed to each physical device in the network in order to modify its behavior, or (5) if not all intents are satisfied, results or alerts are pushed to the user but the configuration change is not deployed.

Making and Recommending Changes to the Network

The system may use results of user initiated queries to recommend changes to the network. These recommendations may be specific to results of a particular query. For example, if a diff query determines that an earlier snapshot better meets an intent parameter for particular devices or a particular region of the network, the system can recommend that the configuration for those devices or that particular region be returned to their configurations as in the earlier snapshot. In this case, the system can also automatically take a new pre-deployment snapshot of the network as though the proposed change had been made and verify that a set of intents for the changed devices is satisfied. The system can also notify a user of the proposed change and results of the pre-deployment verification.

Alternatively, if the pre-deployment verification indicates that all intents are satisfied, the system may automatically make the changes and notify the user.

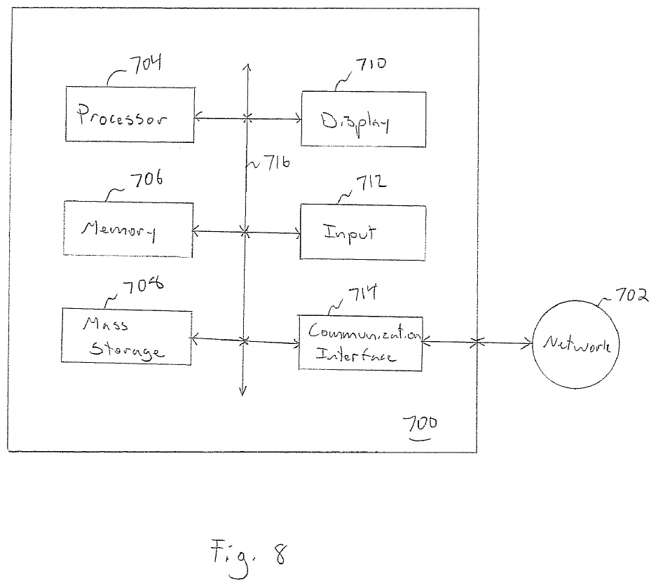

FIG. 8 illustrates a computer system 700 that can be used to execute network verification methods in accordance with embodiments of the present invention. Thus, the computer system 700 may represent the network verification system 100 (FIG. 1), the network modeler 205 (FIG. 2) or any other computing device referenced herein. The computer system 700 may have stored therein machine-executable instructions that can be executed to cause the computer system 700 to perform any one or more of the methods or computer-based functions disclosed herein. The computer system 700 may operate as a stand-alone device or may be connected to other computer systems or devices via a network 702.

As shown in FIG. 8, the computer system 700 includes a processor 704, a memory 706, mass data storage 708, a display 710, input devices 712, a communication interface 714, which may all be connected to a communication bus 716. Machine executable software programs, applications and/or instructions that are operable to cause the computer system to perform any of the acts or operations described herein may be stored in the memory 706 and/or mass data storage 708. The processor 704 generally executes the software programs, applications and/or instructions from memory 706, however, all or part of the software programs, applications and/or instructions can be stored in the mass storage 708. The mass storage 708 may include a disk drive, flash memory or other type of data storage medium. In addition to storing software programs, applications and/or instructions, the mass storage 708 can be used to store any data that is collected, manipulated and/or generated in connection with any one or more of the methods or computer-based functions disclosed herein.

The display 710 is used to display information to a user and may also receive input from the user (in the case of a touch-screen). Additionally, the computer system 700 may include one or more additional input devices 712, such as a keyboard or mouse for enabling the user to interact with the computer system 700. The computer system 700 may also include a communication interface 714 such as the network device interface that enables communications via the communications network 702. The network 702 may include wired networks, wireless networks, or combinations thereof. The communication interface 714 network may enable communications via any number of communication standards.

It will be apparent that other arrangements of computer systems can be utilized. For example, the computer system can be distributed or cloud-based. Additionally, the methods and systems may also be embedded in a computer program product that includes a non-transient machine-readable storage medium having machine-readable instructions stored thereon, and that, when executed, cause the computer system to carry out operations referenced herein. Accordingly, the methods and systems referenced herein may be realized in hardware or a combination of hardware and software.

The foregoing detailed description of the present invention is provided for the purposes of illustration and is not intended to be exhaustive or to limit the invention to the embodiments disclosed. Accordingly, the scope of the present invention is defined by the appended claims.

What is claimed is:

1. A network verification computer system for a network that includes a plurality of network devices having network interfaces that are connected to each other through data communication links, the computer system comprising a processor that is programmed to:
generate a user-interface configured to receive queries from a user that are input using the input device, and request verification of network policies and predictions of network behavior, and
process the queries using a graph data structure that stores information about the network in a plurality of forwarding nodes and forwarding edges to generate query results that are displayed to the user, wherein
each of the forwarding nodes represents a set of packets to be processed at one of a plurality of network locations, the network locations including first and second network locations that are within a same one of the network devices, and
the plurality of forwarding nodes include a first forwarding node representing a first set of packets to be processed at the first network location, a second forwarding node representing the first set of packets to be processed at the second network location, a third forwarding node representing a second set of packets to be processed at the first network location, and a fourth forwarding node representing the second set of packets to be processed at the second network location, and each of the first, second, third, and fourth forwarding nodes is associated with attributes of the same one of the network devices.

2. The network verification computer system of claim 1, wherein
each of the forwarding edges represents packet processing rules of one of the forwarding nodes.

3. The network verification computer system of claim 1, wherein
the processor processes one of the queries that includes a traffic criteria and a location criteria, to generate a query result that includes one or more sets of packets that meet the traffic criteria and one or more network devices that meet the location criteria.

4. The network verification computer system of claim 3, wherein
in the graph data structure, each of the forwarding nodes is associated with attributes of one of the network devices, and
the processor examines the forwarding nodes and forwarding edges of the graph data structure to find the sets of packets that meet the traffic criteria and examines the attributes of the network devices to find the network devices that meet the location criteria.

5. The network verification computer system of claim 1, wherein the graph data structure stores information about the network at a first point in time in a first set of forwarding nodes and forwarding edges and stores information about the network at a second point in time that is different from the first point in time in a second set of forwarding nodes and forwarding edges.

6. The network verification computer system of claim 1, wherein the graph data structure is generated based on state information of the network devices.

7. The network verification computer system of claim 6, wherein the network devices are virtual network devices and the state information of the virtual network devices is collected from a controller of a software-defined network.

8. The network verification computer system of claim 7, wherein the processor is further programmed to:
obtain modifications to packet processing rules of the network devices;
generate a graph data structure that stores information about a hypothetical network that includes the network devices with modified packet processing rules; and
verify, using the graph data structure, whether or not the modifications comply with the network policies.

9. The network verification computer system of claim 8, wherein the processor is further programmed to:
upon verifying that the modifications comply with the network policies, send the modifications to the network devices for adoption by the network devices.

10. A computer-implemented method of verifying a network that includes a plurality of network devices having network interfaces that are connected to each other through data communication links, said method comprising:
generating a user-interface configured to receive queries from a user that are input using the input device, and request verification of network policies and predictions of network behavior, and
processing the queries using a graph data structure that stores information about the network in a plurality of forwarding nodes and forwarding edges to generate query results that are displayed to the user, wherein
each of the forwarding nodes represents a set of packets to be processed at one of a plurality of network locations, the network locations including first and second network locations that are within a same one of the network devices, and
the plurality of forwarding nodes include a first forwarding node representing a first set of packets to be processed at the first network location, a second forwarding node representing the first set of packets to be processed at the second network location, a third forwarding node representing a second set of packets to be processed at the first network location, and a fourth forwarding node representing the second set of packets to be processed at the second network location, and each of the first, second, third, and fourth forwarding nodes is associated with attributes of the same one of the network devices.

11. The method of claim 10, wherein
each of the forwarding edges represents packet processing rules of one of the forwarding nodes.

12. The method of claim 10, wherein
one of the queries includes a traffic criteria and a location criteria, and
the processing of said one of the queries generates a query result that includes one or more sets of packets that meet the traffic criteria and one or more network devices that meet the location criteria.

13. The method of claim 12, wherein
in the graph data structure, each of the forwarding nodes is associated with attributes of one of the network devices, and
during the processing of said one of the queries, the forwarding nodes and forwarding edges of the graph data structure are examined to find the sets of packets that meet the traffic criteria and the attributes of the network devices are examined to find the network devices that meet the location criteria.

14. The method of claim 10, wherein the graph data structure stores information about the network at a first point in time in a first set of forwarding nodes and forwarding edges and stores information about the network at a second point in time that is different from the first point in time in a second set of forwarding nodes and forwarding edges.

15. The method of claim 10, wherein the graph data structure is generated based on state information of the network devices.

16. The method of claim 15, wherein the network devices are virtual network devices and the state information of the virtual network devices is collected from a controller of a software-defined network.

17. The method of claim 16, further comprising:
obtaining modifications to packet processing rules of the network devices;
generating a graph data structure that stores information about a hypothetical network that includes the network devices with modified packet processing rules; and
verifying, using the graph data structure, whether or not the modifications comply with the network policies.

18. The method of claim 17, further comprising:
upon verifying that the modifications comply with the network policies, sending the modifications to the network devices for adoption by the network devices.

19. A non-transitory computer readable medium comprising instructions to be executed on a processor of a network verification computer system to carry out a method of verifying a network that includes a plurality of network devices having network interfaces that are connected to each other through data communication links, said method comprising:
generating a user-interface configured to receive queries from a user that are input using the input device, and request verification of network policies and predictions of network behavior, and
processing the queries using a graph data structure that stores information about the network in a plurality of forwarding nodes and forwarding edges to generate query results that are displayed to the user, wherein
each of the forwarding nodes represents a set of packets to be processed at one of a plurality of network locations, the network locations including first and second network locations that are within a same one of the network devices, and
the plurality of forwarding nodes include a first forwarding node representing a first set of packets to be processed at the first network location, a second forwarding node representing the first set of packets to be processed at the second network location, a third forwarding node representing a second set of packets to be processed at the first network location, and a fourth forwarding node representing the second set of packets to be processed at the second network location, and each of the first, second, third, and fourth forwarding nodes is associated with attributes of the same one of the network devices.

20. The non-transitory computer readable medium of claim 19, wherein the method further comprises:
obtaining modifications to packet processing rules of the network devices;
generating a graph data structure that stores information about a hypothetical network that includes the network devices with modified packet processing rules; and
verifying, using the graph data structure, whether or not the modifications comply with the network policies.
